(19) United States
(12) Patent Application Publication
(10) Pub. No.: US 2005/0213953 A1
(43) Pub. Date: Sep. 29, 2005

(54) Adapter cover, photographic print producing method, and lens-fitted photographic film unit system

(75) Inventor: Takeshi Masuda, Minami-ashigara-shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., MINAMI-ASHIGARA-SHI (JP)

(21) Appl. No.: 11/090,149

(22) Filed: Mar. 28, 2005

(30) Foreign Application Priority Data
Mar. 26, 2004 (JP) 2004-093553

(51) Int. Cl. G03B 17/02

(52) U.S. Cl. 396/6

(57) ABSTRACT

Adapter covers are prepared for designating a sepia photofinishing, a monochrome photofinishing, a color photofinishing, and a frame-adding photofinishing. A user selects one of the adapter covers that designates the user's intended photofinishing, and attaches it to the lens-fitted photographic film unit. The lens-fitted photographic film unit is provided with three photography data optical paths for recording three bit marks as optical codes. The photography data optical paths are selectively covered by the adapter cover, and the optical code corresponding to the type of the adapter cover is recorded on a photographic film. A photographic print is produced by the photofinishing designated by the optical code recorded correspondingly to each picture frame.

### BACKGROUND OF THE INVENTION

1. Field of the Invention

The present invention relates to an adapter cover for designating a photofinishing type, a method for producing photographic print of the designated photofinishing type, and a lens-fitted photographic film unit system.

2. Background Arts

A lens-fitted photographic film unit having unit body with an integrated simple photographic mechanism and with a preloaded unexposed photographic film is popularly used as a simple camera. The lens-fitted photographic film unit having an integrated data imprinting device is also known. Japanese Patent Laid-Open Publication Number 08-211478, for example, discloses a photographic data imprinting device which takes in external light via a light entering window on a front face of the unit body in response to shutter release and guides it to the photographic film with a light guide formed of transparent resin, so as to imprint a mark on the outside of a picture frame. In printing process, the imprinted mark is read out and a photographic print is printed in the print size designated by the imprinted mark. Furthermore, the lens-fitted photographic film unit capable of designating photofinishing type is known. A photograph taken by this lens-fitted photographic film unit is printed to be, for example, a sepia or a monochrome photographic print.

For all images on a single roll of photographic film taken by the lens-fitted photographic film unit that designates a particular photofinishing type, only the designated photofinishing is performed. A user thus needs to purchase a particular photographic film unit that designates the user's intended photofinishing type. This is inconvenient for the user and it is desired that the user may easily designate a plurality of photofinishing types using a single lens-fitted photographic film unit.

### SUMMARY OF THE INVENTION

A main object of the present invention is to provide an adapter cover, a lens-fitted photographic film unit, and a method for producing a photographic print that enable a user to have a photographic print photofinished by photofinishing of the user's intended type without using an exclusive camera for a particular photofinishing.

Another object of the present invention is to provide the adapter cover which enables the user to change an optical code for designating the photofinishing type within a single roll of the photographic film.

Still another object of the present invention is to provide the adapter cover needs only be attached to the camera to imprint the user's intended optical code.

In order to achieve the above objects and other objects, the adapter cover of the present invention is attached to the camera for blocking at least one optical data path. The camera is provided with at least one lighting window on the front face of the camera body, and at least one optical data path for imprinting a bit mark on the outside of an exposure area on the photographic film by guiding the external light from the lighting window to the photographic film. A combination of the bit marks expresses the optical code for designating the photofinishing type.

In a preferred embodiment of the present invention, the adapter cover is provided with a front adapter cover and a rear adapter cover and accommodates a camera such as the lens-fitted photographic film unit. The photofinishing types are the sepia photofinishing, the monochrome photofinishing, the color photofinishing, and the frame-adding photofinishing.

The camera is provided with a first and a second lighting windows, and a first, a second and a third optical data paths. The external light from the first lighting window enters the first and the second optical data paths, while the external light from the second lighting window enters the third optical data path. Up to three bit marks are thus imprinted on the photographic film.

A first, a second and a third adapter covers are prepared and selectively used in accordance with the desired photofinishing type. Each adapter cover is formed of opaque plastic. The first adapter cover has a cover opening which faces the first lighting window for imprinting a first bit mark on the photographic film. The second adapter cover has the cover opening which faces the second lighting window for imprinting a second and a third bit marks on the photographic film. The third adapter cover blocks both the first and the second lighting windows.

In each of the first and the second adapter covers, a light guide is disposed for guiding the external light and flash light to the lighting windows. In the first adapter cover, a first end of the light guide is located between the lighting windows and the case opening, while a second end of the light guide between a flash light emitting unit and a flash opening. In the second adapter cover, one end of the light guide is located between the lighting windows and the plurality of case openings. An opening/closing member is slidably disposed in front of or behind the light guide for selectively opening/closing the lighting windows to be operated from the outside of the adapter cover.

The lens-fitted photographic film unit system of the present invention is provided with the lens-fitted photographic film unit containing a preloaded photographic film, and at least one adapter cover to be removably attached to the lens-fitted photographic film unit. The lens-fitted photographic film unit is provided with a unit body having a photographic mechanism, at least one lighting window formed on the front face of the unit body, and at least one optical data path for guiding the external light from the lighting window to the photographic film.

The method for producing the photographic print of the present invention is to read out both the image recorded on the photographic film and the optical code expressed by at least one bit mark imprinted at the time of photographing, to process an image in accordance with the optical code, and then to print the processed image on a recording media.

According to the present invention, it is possible to designate by simply selecting and attaching one of the adapter covers. It is also possible to imprint various optical codes designating various photofinishing types on a single roll of the photographic film by changing the adapter cover. Furthermore, it is possible to change the optical code by shifting the opening/closing member provided to the adapter cover, in the preferred embodiment of the present invention.

Accordingly, it is possible to produce the photographic print of the intended photofinishing designated at the time of photographing, by reading out the image and the optical code recorded on photographing and processing the image in accordance with the optical code. It is also possible to process the image in a more complicated manner by combining the optical data and film data prerecorded on the photographic film.

### BRIEF DESCRIPTION OF THE DRAWINGS

One with ordinary skill in the art would easily understand the above-described objects and advantages of the present invention when the following detailed description is read with reference to the drawings attached hereto.

FIG. 1 is a perspective view illustrating an adapter cover and a lens-fitted photographic film unit;

FIG. 2 is an exploded perspective view illustrating a constitution of the lens-fitted photographic film unit;

FIG. 3 is an exploded perspective view illustrating a constitution of an optical data imprinting device of the lens-fitted photographic film unit, and FIG. 3A is a perspective view of a main portion;

FIG. 4 is a cross-sectional view of a main part of an dark box;

FIG. 5 is an explanatory view illustrating a fifth light guide provided to a front adapter cover;

FIGS. 6A to 6D are explanatory views illustrating relations between bit marks imprinted by each adapter cover and photofinished photographic prints;

FIG. 7 is a schematic view illustrating a constitution of a digital printer;

FIG. 8 is an exploded perspective view illustrating an embodiment in which the bit mark can be changed; and

FIGS. 9A and 9B are explanatory views illustrating the relations between bit marks imprinted by the adapter cover shown in FIG. 8 and the photofinished photographic prints.

### PREFERRED EMBODIMENTS OF THE INVENTION

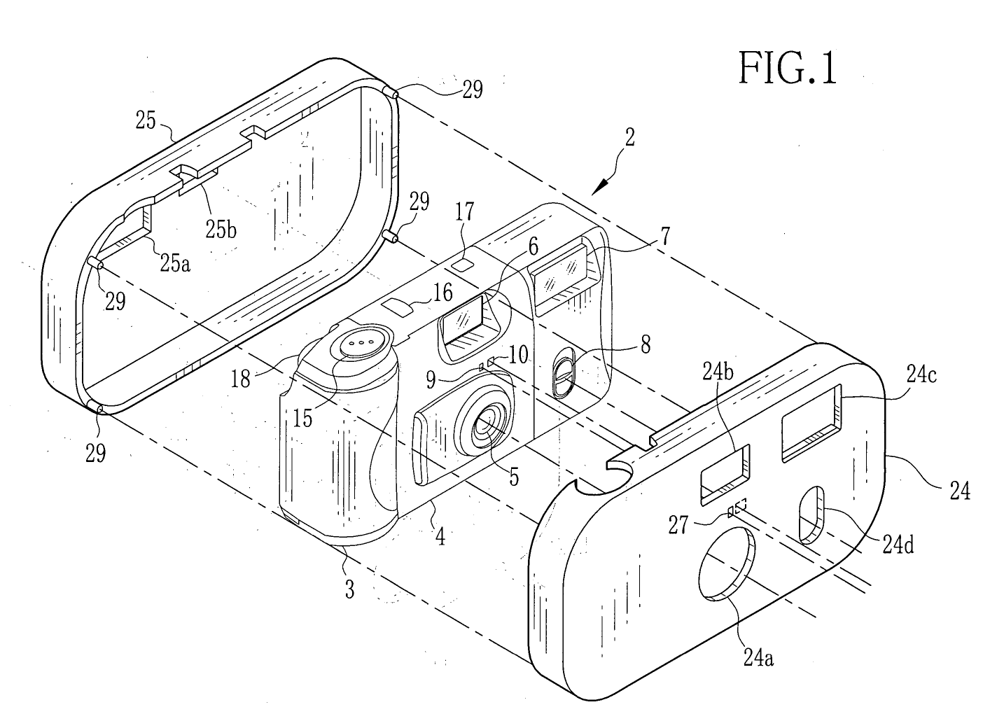

As shown in FIG. 1, a lens-fitted photographic film unit 2 comprises a unit body (camera body) 3 incorporating various photographic mechanisms, a film cartridge preloaded on manufacture of the unit body 3 in the factory, and a label 4 adhered around the periphery of the unit body 3. The label 4 has openings for exposing various parts of the unit body 3.

The front face of the unit body 3 is provided with a taking lens 5, an objective lens 6, a flash light emitting unit 7, a flash charging switch 8, and a first and a second lighting windows 9 and 10 for imprinting optical data. The top face of the unit body 3 is provided with a shutter button 15, a film counter window 16, and an opening 17. The rear face of the unit body 3 exposes a part of a winding wheel for taking up the exposed photographic film.

The lens-fitted photographic film unit 2 performs daylight photographing when the flash charging switch 8 is set in an OFF position as shown in FIG. 1, and flash photographing when the flash charging switch 8 is set in an ON position, upward from the OFF position. Although it is not shown in FIG. 1, a charge completion indicator protrudes from the opening 17 in conjunction with the shift of the flash charging switch 8 to the ON position. The charge completion indicator is a light guide formed of a transparent plastic, for guiding illuminating or blinking light of a flash charge completion lamp and discharging them at an end face when the flash light emitting unit 7 completes charging.

In daylight photographing, the external light is guided through the first and the second lighting windows 9 and 10 into the unit body 3 then optically prints an approximately square-shaped bit mark on the outside of a picture frame to correspond to the position of the picture frame on the photographic film. In flash photographing, the flash light emitted toward a subject is reflected on the subject and enters the unit body 3 via the first and the second lighting windows 9 and 10 to optically imprint the bit mark in the same way as the daylight photographing.

By imprinting various bit marks by simply changing the adapter covers, it is possible to obtain photographs to be processed not only with color image processing but also other image processing. Such image processing are the image processing for sepia toning (hereinafter referred to as sepia photofinishing), for monochrome toning (hereinafter referred to as monochrome photofinishing), and for merging a predetermined pattern as the frame with the image (hereinafter referred to as frame-adding photofinishing). Note that the image processing is not limited to them.

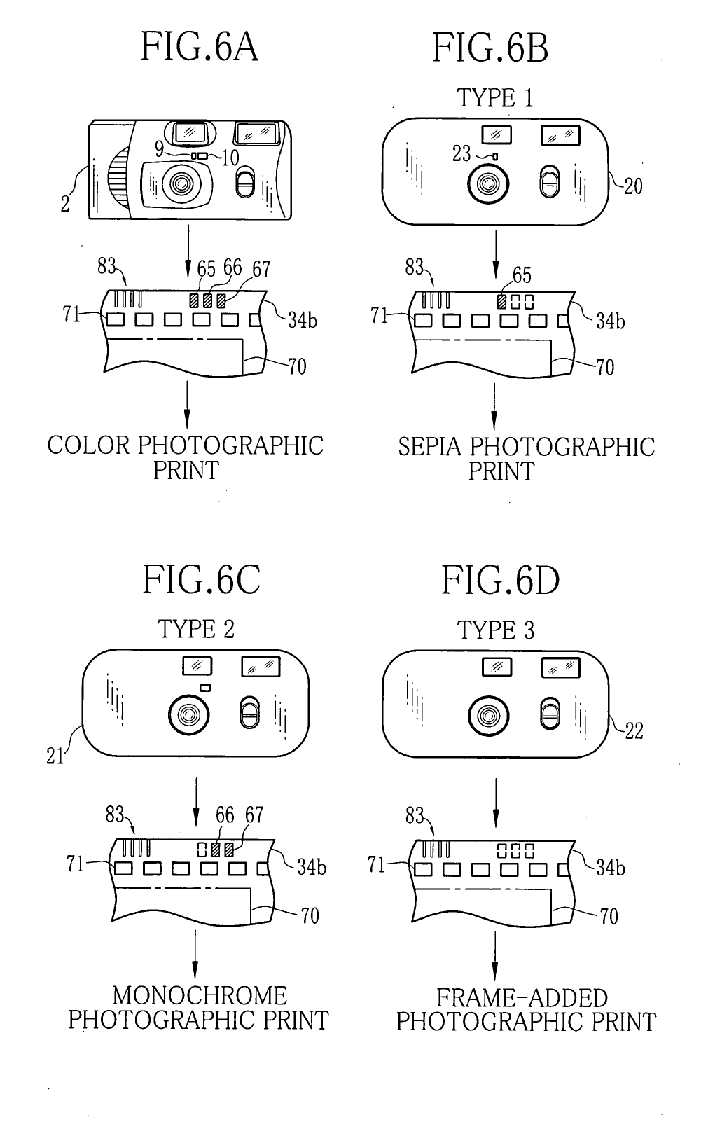

As shown in FIG. 6, three kinds of adapter covers are prepared as an adapter cover 20 (Type 1) for blocking the second lighting window 10 on the front face of the lens-fitted photographic film unit 2, an adapter cover 21 (Type 2) for blocking the first lighting window 9, and an adapter cover 22 (Type 3) for blocking both lighting windows 9 and 10. At least a part of the optical data path is blocked when one of the adapter covers 20, 21 and 22 is selectively attached to the lens-fitted photographic film unit 2. Note that the present embodiment is exemplified using the adapter cover 20, which blocks the second lighting window 10.

As shown in FIG. 1, the adapter cover 20 comprises a front adapter cover 24 and a rear adapter cover 25, for respectively covering the front side and the rear side of the lens-fitted photographic film unit 2. Both of the front and the rear adapter covers 24 and 25 are formed of opaque plastics. The front adapter cover 24 is provided with an opening (cover opening) 27 for exposing the first lighting window 9 of the lens-fitted photographic film unit 2, as well as openings 24a, 24b, 24c, and 24d for exposing the taking lens 5, the objective lens 6, the flash light emitting unit 7, and the flash charging switch 8 respectively. The rear adapter cover 25 is provided with opening 25a for exposing the winding wheel 18, and a rear viewfinder window 25b. The front and the rear adapter covers 24 and 25 are attached to hold the lens-fitted photographic film unit 2 from the front and rear sides, fitting a protrusion 29 of the adapter rear cover 25 into a fitting hole (not shown) of the front cover 24. Thereby, the taking lens 5, the objective lens 6, and the first lighting window 9 are exposed through the openings on the front and the rear adapter covers 24 and 25. The shutter button 15, the film counter window 16, and the light guide are exposed through the openings on the upper face of the adapter cover 20. The second lighting window 10 is covered by the front adapter cover 24.

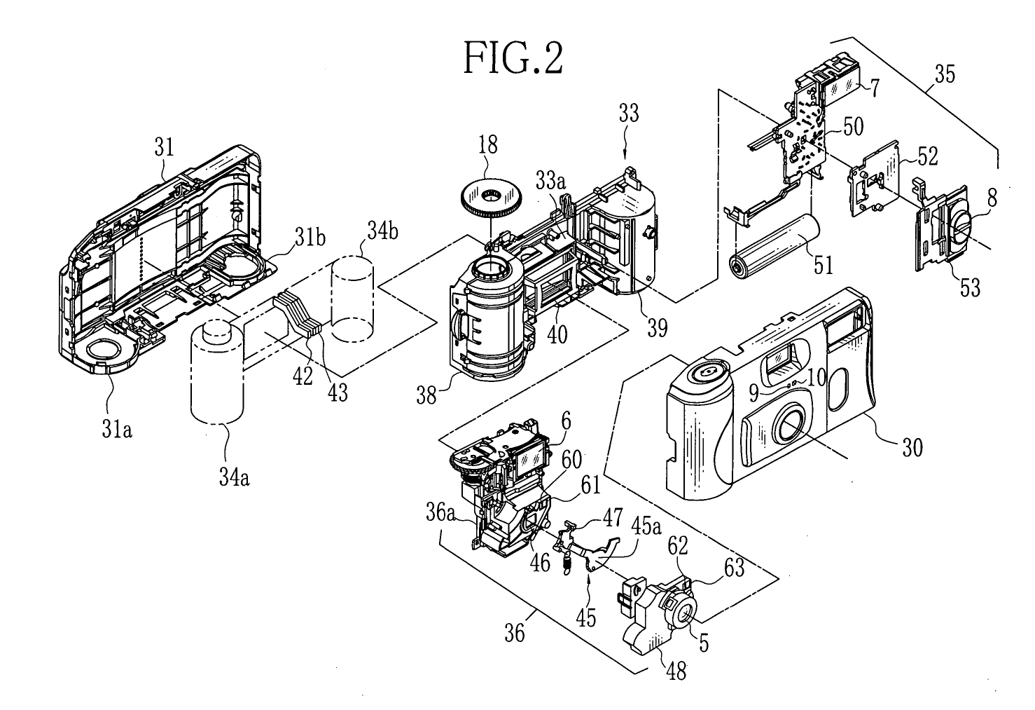

As shown in FIG. 2, the lens-fitted photographic film unit 2 comprises a front cover 30 and a rear cover 31. Inside of the covers 30 and 31, a body base 33, a cartridge 34a, a photographic film 34b, a flash unit 35 are mounted.

A cartridge chamber 38 for accommodating a cartridge 34a is disposed at one end of the base body 33, and a film roll chamber 39 for accommodating a roll of unexposed photographic film 34b is disposed at the other end across the exposure opening 40 from the cartridge chamber 38. The winding wheel 18 is rotatably provided on top of the cartridge chamber 38. Having a shaft engaging with the spool of the cartridge 34a, the winding wheel 18 takes up the exposed photographic film 34b into the cartridge 34a as rotated in a film winding direction.

The exposure unit 36 is provided in front of the exposure opening 40. A portion 33a of the body base 33 and a portion 36a of the exposure unit 36 are engaged with each other to form a dark box, which guides photographic light penetrating the taking lens 5 to the exposure opening 40. A first and a second light guides 42 and 43 are attached within the dark box.

The rear face of the body base 33 is open, and is light-shielded when the rear cover 31 is attached thereto after the cartridge 34a and the photographic film 34b are loaded. The bottoms of the cartridge chamber 38 and the film roll chamber 39 are open, too. The rear cover 31 is provided with pull-tab type lids 31a and 31b, which have thin portions and open and close freely. The lid 31a covers the bottom of the film roll chamber 39, while the lid 31b covers the bottom of the cartridge chamber 38 and is opened when the exposed cartridge 34a is removed from the unit body 3.

The exposure unit 36 is a unit having the taking lens 5, a shutter mechanism, a film winding stop mechanism, a shutter charge mechanism, a film counting mechanism, and a finder optical system integrally mounted therein. The finder optical system is a reverse-Galilean finder including the concave objective lens 6 and a convex eyepiece.

The shutter mechanism is a kick type that kicks an end 47 of a shutter blade 45 in response to a shutter release, such that the shutter blade 45 swings back and force once in front of a shutter opening 46 while cutting across a photographing optical axis 5a. The shutter opening 46 is provided on the photographing optical axis 5a at the front part of the dark box of the exposure unit 36. A photography optical path opening/closing portion 45a is provided on the shutter blade 45 in the opposite side of the end 47 and is covered with a shutter cover 48. The shutter cover 48 has a fixed aperture formed thereon, and the taking lens 5 is attached at the front side of the fixed aperture.

The flash unit 35, which comprises a flash board 50, a power supply battery 51, a guide plate 52, a switch plate 53 and so on, is removably attached between the body base 33 and the front cover 30. The flash board 50 has a flash circuit, a main capacitor, a synchronizing contact, and a switch plate 53 integrally mounted therein. The flash charging switch 8 is formed on the switch plate 53 to open/close the flash circuit as sliding with support of the guide plate 52. When the flash charging switch 8 is turned on, the flash unit 35 charges a main capacitor using the power from the power supply battery 51, and applies a triggering signal to a discharge tube in response to the synchro switch. The charge accumulated in the main capacitor is thereby discharged to the discharge tube and the flash light emitting unit 7 emits the flash light toward the subject.

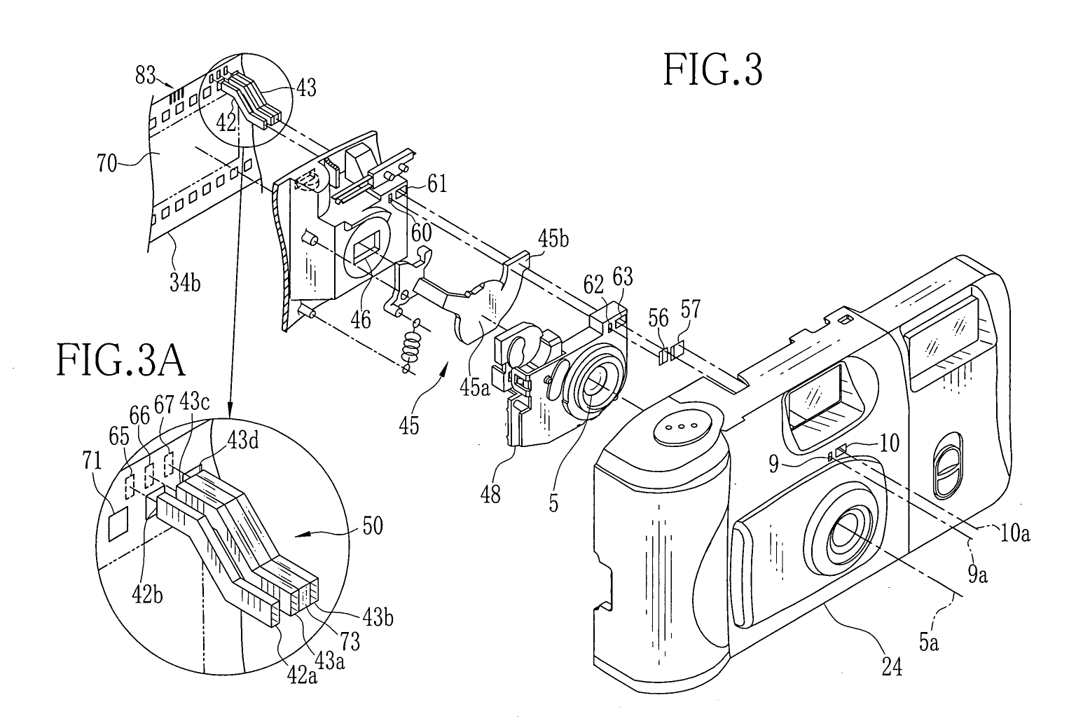

As shown in FIG. 3, the first and the second lighting windows 9 and 10 of different sizes are provided on the first and the second photography data optical paths 9a and 10a respectively. A third and a fourth light guides 56 and 57 formed of transparent plastics are provided behind the first and the second lighting windows 9 and 10 on the front cover 30. The external light from the first lighting window 9 is guided to the first light guide 42 via the third light guide 56, while the external light from the second lighting window 10 is guided to the second light guide 43 via the fourth light guide 57.

The shutter blade 45 in the shutter mechanism has an optical data path opening/closing portion 45b protruding slantwise upward from the photography optical path opening/closing portion 45a. The optical data path opening/closing portion 45b opens or closes a first and a second openings 60 and 61, which are for data imprinting, at a time. The first and the second openings 60 and 61 are respectively provided on the first and the second photography data optical paths 9a and 10a, which guide the external light from the first and the second lighting windows 9 and 10 to incident surfaces 42a, 43a and 43b of the first and the second light guides 42 and 43. Openings 62 and 63 are provided on the shutter cover 48 on the first and the second photography data optical paths 9a and 0a respectively.

The first light guide 42 is provided with the incident surface 42a for taking in the external light from the first lighting window 9, and an exit surface 42b for discharging the external light so as to imprint the bit mark 65 on the photo film 34b. Similarly, the second light guide 43 is provided with the incident surfaces 43a and 43b for taking in the external light from the second lighting window 10, and exit surfaces 43c and 43d for discharging the external light so as to imprint the bit marks 66 and 67 on the photo film 34b. The exit surfaces 42b, 43c and 43d are located close to the photo film 34b to imprint the bit marks 65, 66 and 67 at equal spaces in an edge area outside of perforations 71. A light-shielding partition 73 is provided at the center of the second light guide 43 along with the lengthwise of it, such that the exit surfaces 43c and 43d discharge the lights separately. Note that a reference numeral 70 indicates an exposure area.

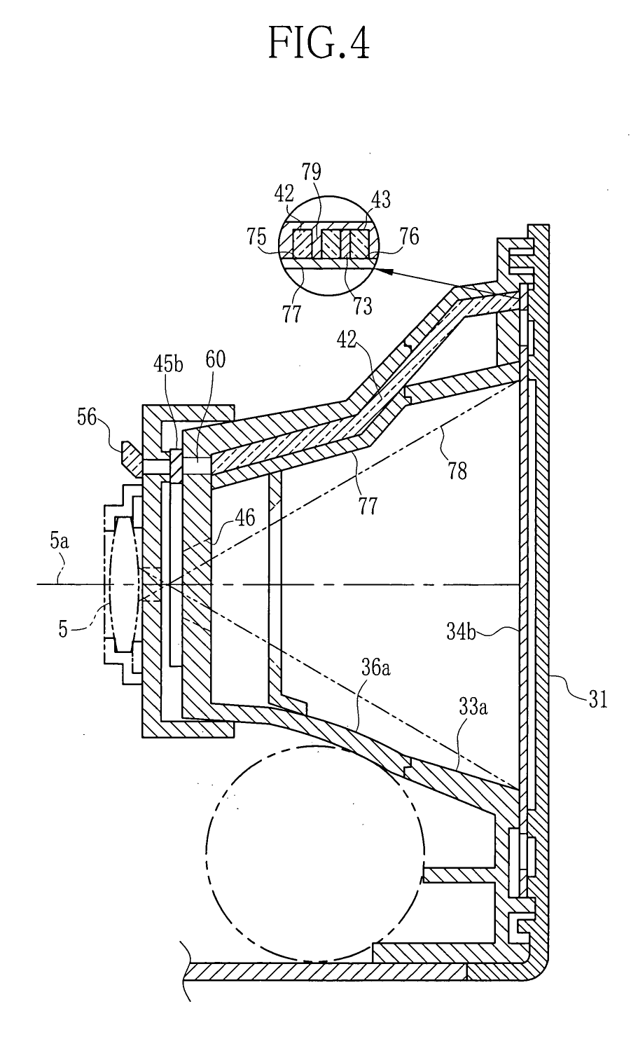

As shown in FIG. 4, the first light guide 42 forms the first photography data optical path 9a that guides the external light entering the dark boxes 33a and 36a from the first opening 60 to a first imprint opening 75. The first photography data optical path 9a and a photography optical path 78 are separated from each other by a light-blocking wall 77 at the upper area within the dark boxes 33a and 36a. Although it is not shown in FIG. 4, the second light guide 43 forms the second photography data optical path 10a that guides the external light entering the dark boxes from the second opening 61 to a second imprinter opening 76, and separated into two paths by the light-blocking wall 77 within the dark boxes. The light-blocking wall 77 prevents the lights in the first and the second photography data optical paths 9a and 10a from entering (leaking into) the optical path 78. The first and the second light guides 42 and 43 are separated from each other by a separation wall 79 that prevents the entrance (leaking) of the lights between the first and the second photography data optical paths 9a and 10a.

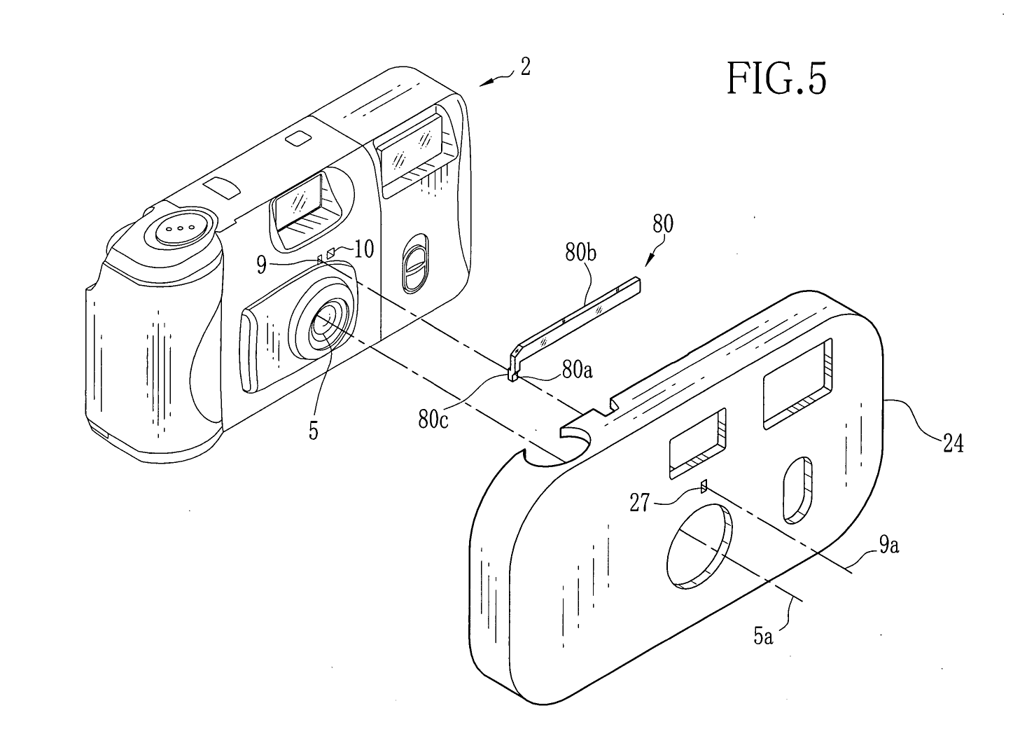

As shown in FIG. 5, a fifth light guide 80 is provided in the rear side of the opening 27 on the front adapter cover 24 for exposing the first lighting window 9, in order to guide either the ambient light or the flash light from the flash light emitting unit 7 to the first lighting window 9. The fifth light guide 80 is formed of a transparent plastic and provided with an ambient light taking portion 80a disposed covering the cover opening 27 from the rear side of the front adapter cover 24, a flash light taking portion 80b disposed below and in front of the flash light emitting unit 7, and an light emitting end 80c for discharging the light from either the ambient light taking portion 80a or the flash light taking portion 80b to the first lighting window 9.

The light emitting end 80c covers the first lighting window 9 when the front adapter cover 24 is attached to the lens-fitted photographic film unit 2. Since the second lighting window 10 is covered with the rear side of the front adapter cover 24 when the front adapter cover 24 is attached to the lens-fitted photographic film unit 2, neither the ambient light nor the flash light from the fifth light guide 80 enters the second lighting window 10.

Although the present embodiment is exemplified using the adapter cover 20 for guiding the ambient light or the flash light to the first lighting window 9, the constitution of the adapter cover 20 is in common with that of the adapter cover 21 of the Type 2 for guiding the ambient light or the flash light to the second lighting window 10 while covering the first lighting window 9. In this case, the ambient light taking portion 80a of the fifth light guide 80 covers the opening for exposing the second lighting window 10 on the front adapter cover of the adapter cover 21. In addition, the light emitting end 80c covers the second lighting window 10 when the adapter cover 21 is attached to the lens-fitted photographic film unit 2. The light emitting end 80c discharges the light from the ambient light taking portion 80a or the flash light taking portion 80b to the second external light emitting window 10.

Although the fifth light guide 80 of the adapter covers 20 and 21 stated above is provided with both the ambient light taking portion 80a and the flash light taking portion 80b, the fifth light guide 80 may be provided with either one of them. The adapter cover 22 for covering both the first and the second lighting windows 9 and 10 is not provided with the fifth light guide 80.

As shown in FIG. 6A, the optical codes in the form of three bit marks 65, 66 and 67 are imprinted on the outside of the perforations 71 on the photographic film 34b photographed by the lens-fitted photographic film unit 2 without the adapter cover 20. As shown in FIG. 6B, the optical code in the form of a single bit mark 65 is imprinted on the outside of the perforations 71 on the photographic film 34b photographed by the lens-fitted photographic film unit 2 with the adapter cover 20 of Type 1 attached thereto. As shown in FIG. 6C, the optical codes in the form of two bit marks 66 and 67 are imprinted on the outside of the perforations 71 on the photographic film 34b photographed by the lens-fitted photographic film unit 2 with the adapter cover 21 of the Type 2 attached thereto. As shown in FIG. 6D, no bit mark is imprinted on the outside of the perforations 71 on the photographic film 34b photographed by the lens-fitted photographic film unit 2 with the adapter cover 22 of Type 3 attached thereto.

A film data 83 is exposed preliminarily in a position outside the perforations 71, avoiding overlapping the dot marks 65 to 67 on the photographic film 34b, as shown in FIG. 3. The film data 83 are barcodes carrying such identification data of the photo film 34b as film sensitivity, a film type, a lot number, and a maker, and are recorded as latent information in the manufacture of the photographic film 34b to be visualized after development of the photo film 34b. The images on the photo film 34b are printed based on the film data 83 because the photo film 34b may slightly vary in coloring density at different manufacturers or lot numbers even with the same film sensitivity.

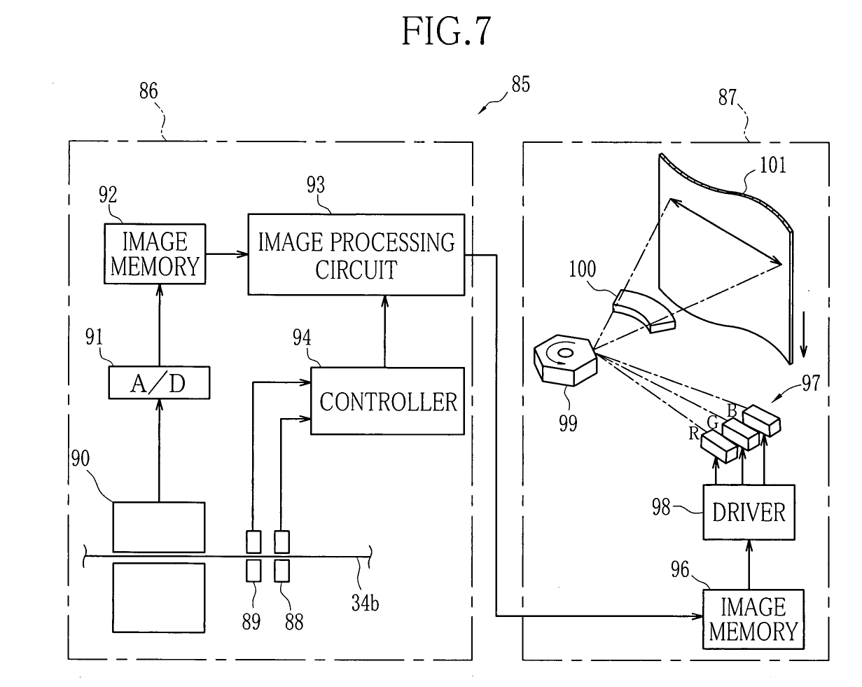

As shown in FIG. 7, a digital printer 85 comprises an input section 86 and an output section 87. The input section 86 comprises a first and a second photo sensors 88 and 89 for reading the film data 83 and the bit marks 65, 66 and 67 on the developed photo film, a scanner 90 for scanning the color image on each frame of the photo film 34b, an A/D converter 91, an image memory 92, an image processing circuit 93, and a controller for controlling all of them.

The developed photo film 34b is transported by a transport mechanism (not shown) to the scanner 90 via the photo sensors 88 and 89. In this transportation, the film data 83 on the photo film 34b is read out by the first photo sensor 88 and the dot marks 65 to 67 of each frame are read out by the second photo sensor 89. The read out film data 83 and the dot marks 65 to 67 are sent to the controller 94, which controls the image processing circuit 93 based on the film data 83 and the dot marks 65, 66 and 67.

The scanner 90 comprises a film carrier, a lamp, a mixing box for illuminating the picture frame set on the film carrier by diffusing the light from the lamp, a lens for focusing the color image in the picture frame reading the photographed frame onto an image sensor (CCD). In every feeding of the frame of the photo film 34b, the scanner 90 performs three color separation and sends obtained photoelectric signals to the A/D converter 91.

By digitally converting the photoelectric signals, the A/D converter 91 converts the color image in the photographed frame into three-color image data. The three-color image data is written in an image memory 92, and then the image process circuit 93 reads out the three-color image data and performs image processing based on the film data 83 and the dot marks 65, 66 and 67 under control of the controller 94.

For example, when three bit marks 65 to 67 are imprinted on the photographic film 34b as shown in FIG. 6A, a color photofinishing, which is a regular one, is performed on the corresponding picture frame. When a single bit mark 65 is imprinted as shown in FIG. 6B, the sepia photofinishing is performed on the corresponding picture frame. When two bit marks 66 and 67 are imprinted as shown in FIG. 6c, the monochrome photofinishing is performed on the corresponding picture frame. When no bit mark is imprinted as shown in FIG. 6D, the frame-adding photofinishing is performed on the corresponding picture frame. The image data is outputted to the image memory 96 of the output section 87 after photofinishing.

The output section 87 comprises the image memory 96, a laser unit 97 for radiating red, blue and green laser beams, a driver 98 for controlling output of the laser unit 97 based on the processed image data in the image memory 96, a polygonal mirror 99, an Fθ lens 100, a continuous color photographic paper 101, and a conveyer mechanism (not shown) for conveying the color photographic paper 101.

While the continuous color photographic paper 101 is transported in its lengthwise direction, line exposure of the images in each picture frame is performed on the color photographic paper 101 by laser beam scanning of the polygonal mirror 99 rotating rapidly. The exposed color photographic paper 101 is cut by each frame after developed.

The following is an explanation about the operation of the above constitution. By selectively putting the adapter covers 20, 21 or 22 on the lens-fitted photographic film unit 2 with the first and the second lighting windows 9 and 10 based on the desired photofinishing type and having the photographed image processed, the user can obtain a photographic print of the desired photofinishing type.

For example, each rear adapter cover 25 of the adapter covers 20 to 22 carries a sample image of the picture to be obtained by its specific photofinishing, such that the user may select the adapter covers 20 to 22 in accordance with the intended photofinishing type. In order to obtain a color photographic print, the user photographs with the lens-fitted photographic film unit 2 without any adapter covers (see FIG. 6A). Thereby, three dot marks 65, 66 and 67 are imprinted on the photo film 34b along with the photographed image. In order to obtain the sepia photographic print, the user puts the adapter cover 20 of Type 1 on the lens-fitted photographic film unit 2 then photographs (FIG. 6B). A single dot mark 65 is thus imprinted on the photo film 34b along with the photographed image. In order to obtain the monochrome photographic print, the user puts the adapter cover 21 of Type 2 on the lens-fitted photographic film unit 2 then photographs (FIG. 6C). Two dot marks 66 and 67 are thus imprinted on the photo film 34b along with the photographed image. In order to obtain a frame-added photographic print, the user puts the adapter cover 22 of Type 3 on the lens-fitted photographic film unit 2 then photographs (FIG. 6D). No dot mark is thus imprinted on the photo film 34b and only the photographed image is imprinted.

After photographing, the lens-fitted photographic film unit 2 is removed from the adapter covers 20, 21 or 22 and handed to a photofinisher. The photofinisher reads out the bit marks 65 to 67 imprinted on the developed photographic film 34b and the prerecorded film data 83, performs specific photofinishing on each picture frame based on the film data 83 and the bit marks 65 to 67, and then produces the color, the sepia, the monochrome or the frame-added photographic prints.

Furthermore, it is possible to select a plurality of photofinishing using the same adapter cover. In this case, the adapter cover is provided with openings for exposing each of the first and the second lighting window 9 and 10, and an opening/closing member to open and close the openings.

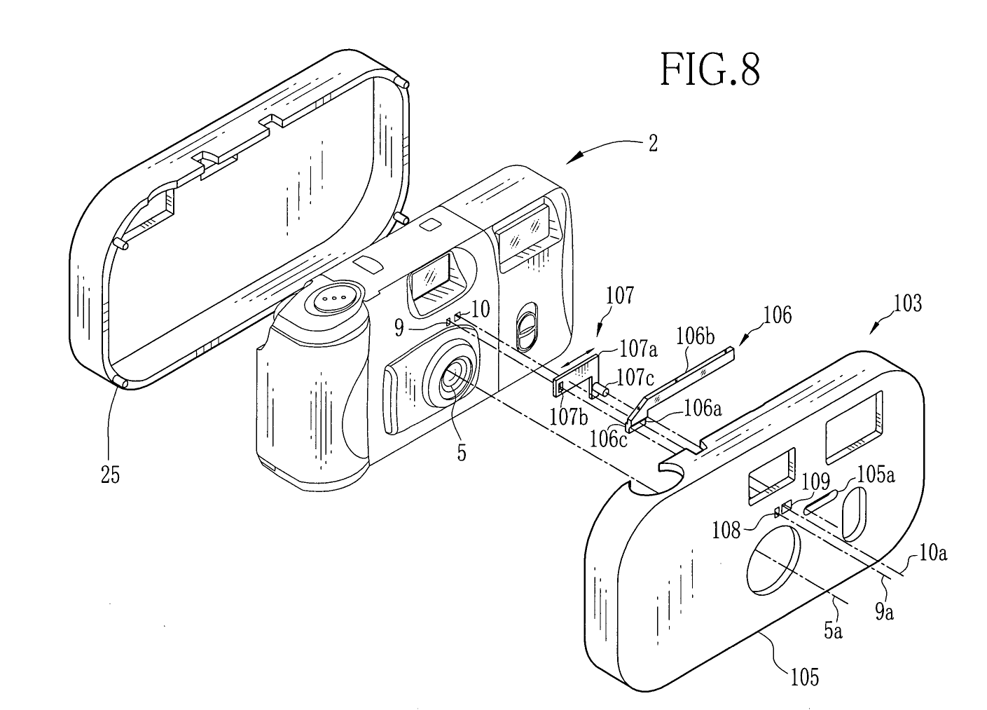

As show2n in FIG. 8, an adapter cover 103 is provided with a front adapter cover 105 and the rear adapter cover 25. The front adapter cover 105 is provided with a light guide 106, an opening/closing member 107, openings 108 and 109 corresponding to the first and the second lighting window 9 and 10 selectively. The light guide 106 is disposed behind the front adapter cover 105 to cover the openings 108 and 109. The opening/closing member 107 is formed of light-shielding plastic and disposed between the light guide 106 and the first and the second lighting windows 9 and 10.

The light guide 106 comprises an external light incident portion 106a covering almost of the entire openings 108 and 109, a flash light incident portion 106b disposed at the lower front of the flash light incident portion 106b disposed under the flash light emitting unit 7, and a light emitting end 106c for emitting the light from the external light incident portion 106a or the flash light incident portion 106b to the first and the second lighting windows 9 and 10.

The opening/closing member 107 comprises a plate member 107a, an opening 107b, and an operating projection 107c. The operating projection 107c protruding toward the front adapter cover 105 is disposed at one end of the opening 107b extending downward. When the adapter cover 103 is attached to the lens-fitted photographic film unit 2, the operating projection 107c protrudes from the left end of an elliptic opening 105a on the front adapter cover 105. Another end of the plate member 107a opposite to the operating projection 107c is provided with an opening 107b of approximately the same size as the first lighting window 9.

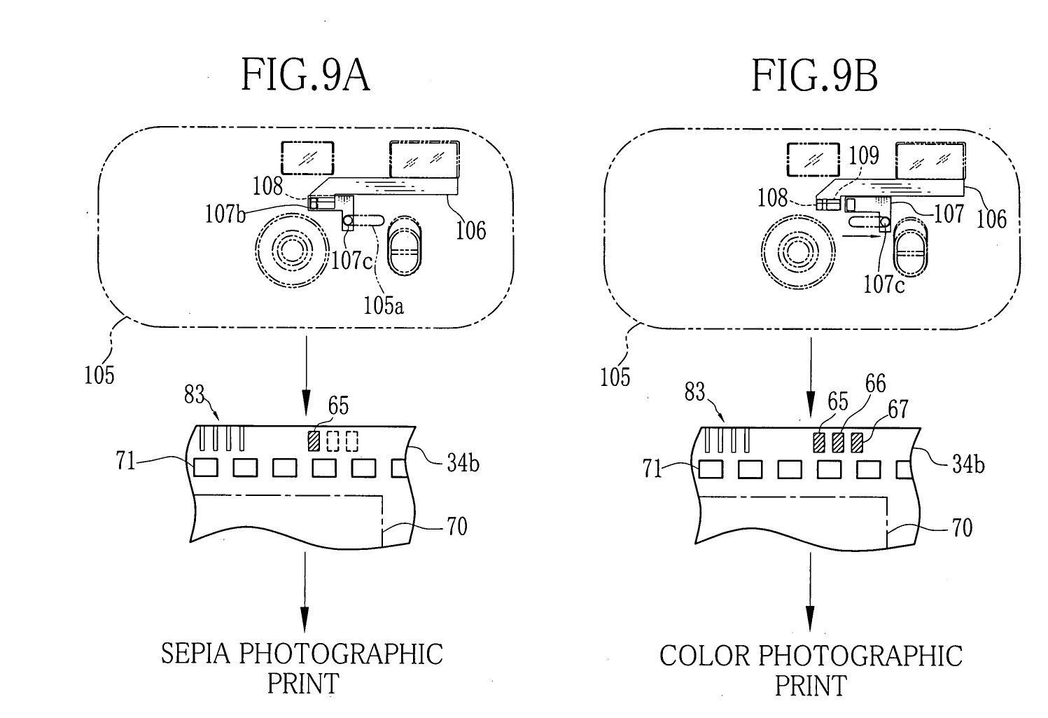

The operation projection 107c is slidable from side to side within a slot 105a. When the operation projection 107c is set in a closing position, the opening 107b opens the first lighting window 9 and the plate member 107a cover the second lighting window 10 (see FIG. 9A). When the operation projection 107c, on the other hand, is set in an opening position, the opening/closing member 107 retreats from the first and the second lighting windows 9 and 10 to open them (see FIG. 9B). Accordingly, the first photography data optical path 9a is allowed to be effective and simultaneously the second photography data optical path 10a is blocked when the opening/closing member 107 is set in the closing position, while both photography data optical paths 9a and 10a are allowed to be effective when the opening/closing member 107 is set in the opening position.

In order to obtain the sepia photographic print for example, the user sets the operating projection 107c in the left end within the slot 105a as shown in FIG. 9A. Thereby, the first photography data optical path 9a is allowed to be effective and simultaneously the second photography data optical path 10a is blocked, and a single bit mark 65 is imprinted on the photographic film 34b.

On the other hand, in order to obtain the color photographic print, the user sets the operating projection 107c in the right end within the slot 105a as shown in FIG. 9B. Thereby, the plate member 107 retreats from the lighting windows 9 and 10 allowing the first and the second photography data optical paths 9a and 10a to be effective, and three bit marks 65 to 67 are imprinted on the photographic film 34b.

After exposing the entire photo film 34b, the lens-fitted photographic film unit 2 is removed from the adapter cover 103 and handed to the photofinisher. The photofinisher reads out the bit marks 65 to 67 imprinted on the developed photographic film 34b and the prerecorded film data 83, performs specific photofinishing on each picture frame based on the film data 83 and the bit marks 65 to 67, and then produces the color, the sepia, the monochrome or the frame-added photographic prints. The picture frame with a single dot mark 65 is processed with the sepia photofinishing, while the picture frame with the three dot marks 65 to 67 is processed with the color photofinishing. Accordingly, the adapter cover 103 enables the user to select two photofinishing types.

In the above embodiment, the first photography data optical path 9a is allowed to be effective and simultaneously the second photography data optical path 10a is covered when the opening/closing member 107 is set in the closing position. Both the first and the second photography data optical paths 9a and 10a become effective when the opening/closing member 107 is set in the opening position. However, it is also possible to form the same optical data as the adapter cover 21 of Type 2 by blocking the first photography data optical path 9a. In this case, the plate member is provided with the opening 107b of approximately the same shape and the size as those of the second lighting window 10. When the opening/closing member 107 is set in the closing position, the opening 107b opens the second lighting window 10 to allow the second photography data optical path 10a to be effective and simultaneously the first lighting window 9 is covered with the plate member 107a. When the opening/closing member 107 is set in the opening position, the opening/closing member 107 retreats from the first and the second lighting windows 9 and 10 to allow both the first and the second photography data optical paths 9a and 10a to be effective.

Furthermore, it is also possible to form the same optical data as the adapter cover 22 of Type 3 by blocking both the first and the second photography data optical paths 9a and 10a. In this case, the opening/closing member 107 is not provided with the opening 107b to cover both the first and the second lighting windows 9 and 10 when it is set in the closing position. On the other hand, if the opening closing member 107 is set in the opening position, it retreats from both the first and the second lighting windows to allow both the fist and the second photography data optical paths 9a and 10a to be effective.

Since the opening/closing member 107 is disposed between the light emitting end 106c and the first and the second lighting windows 9 and 10, as shown in FIG. 8, the flashlight entering from the flash light incident portion 106b and exiting from the light emitting end 106c cannot enter the second lighting window 10.

Although each of the sepia, the monochrome and the frame-adding photofinishing are performed based on the combination of the film data 83 latently prerecorded on the photographic film 34b and the bit marks 65 to 67 in the above embodiment, it is also possible to perform photofinishing based only on the bit marks 65 to 67.

Furthermore, it is also possible to provide more than three kinds of image processing. In this case, for example, the season in which the lens-fitted photographic film unit 2 is to be on the market is prerecorded in the film data 83. By photographing with the lens-fitted photographic unit 2 with the adapter covers 20 to 22 selectively attached thereto, merging a seasonable pattern with the photographed image is designated based on the film data 83 and the bit marks 65 to 67. Thereby, it is possible to increase the number of the types of the photographic print, using the lens-fitted photographic film unit 2 and the adapter covers 20 to 22.

Although the maximum number of the bit marks 65 to 67 to be imprinted is three in the above embodiments, the number of the bit marks to be imprinted is determined based on the number of the photofinishing type.

Note that the present invention is applicable also to the camera in which an unexposed photographic film 34b is replicable.

Although the present invention has been described with respect to the preferred embodiments, the present invention is not to be limited to the above embodiments but, on the contrary, various modifications will be possible to those skilled in the art without departing from the scope of claims appended hereto.

1. An adapter cover removably attached to a camera, said camera including at least one lighting window formed on a front face of a camera body and one or more photography data optical paths for recording bit marks outside an exposure area by guiding the external light from said lighting window to said photographic film, at least one of said bit marks expressing an optical code for designating a photofinishing type, said adapter cover comprising:
a front adapter cover to be attached to said front face of said camera body, said front adapter cover blocking at least one of said photography data optical paths.

2. An adapter cover defined in claim 1, wherein said camera is a lens-fitted photographic film unit having said camera body preloaded with said photographic film.

3. An adapter cover defined in claim 2, further comprising a rear adapter cover for covering a rear face of said lens-fitted photographic film unit to accommodate said lens-fitted photographic film unit together with said front adapter cover, said rear adapter cover engages with said front adapter cover.

4. An adapter cover defined in claim 3, said photofinishing type is sepia photofinishing, monochrome photofinishing, color photofinishing, and frame-adding photofinishing.

5. An adapter cover defined in claim 1, wherein said camera is provided with plural lighting windows and plural photography data optical paths, said front adapter cover covers at least one of said lighting windows.

6. An adapter cover defined in claim 5, wherein said plural lighting windows are a first lighting window and a second lighting window, said plural photography data optical paths are a first photography data optical path, a second photography data optical path, and a third photography data optical path, the external light that enters said first lighting window is directed to said first photography data optical path and said second photography data optical path, the external light that enters said second lighting window is directed to said third photography data optical path.

7. An adapter cover defined in claim 5, wherein said front adapter cover is formed of opaque plastic and covers all of said plural lighting windows.

8. An adapter cover defined in claim 5, wherein said front adapter cover is formed of opaque plastic and provided with a cover opening to face at least one of said plural lighting windows.

9. An adapter cover defined in claim 5, further comprising:
a flash opening formed on said front adapter cover and facing a flash light emitting unit of said camera; and
a light guide provided to said front adapter cover and having a first end located between said lighting window and said cover opening and a second end located between said flash light emitting unit and said flash opening, for guiding said external light and the flash light from said flash light emitting unit to said lighting window.

10. An adapter cover defined in claim 9, wherein one end of said light guide is located between said plural lighting windows and said cover opening.

11. An adapter cover defined in claim 10, further comprising an opening/closing member disposed in front of or behind said light guide, said opening/closing member is operated from outside of said front adapter cover to selectively open and close said plural lighting windows.

12. A lens-fitted photographic film unit system comprising:
A. a lens-fitted photographic film unit preloaded with a photographic film, said lens-fitted photographic film unit comprising:
a unit body having a photographic mechanism;
at least one lighting window formed on a front face of said unit body;
at least one photography data optical path for recording bit marks on the outside of an exposure area by guiding the external light from said lighting window to said photographic film, at least one of said bit marks expressing an optical code designating a photofinishing type;
B. one or more adapter covers removably attached to said front face of said camera body, said adapter cover blocking at least one photography data optical path.

13. A lens-fitted photographic film unit system defined in claim 12, wherein said adapter cover is a set of adapter covers including at least a first adapter cover and a second adapter cover and one of said adapter covers is selected and attached to said unit body, said first adapter cover is formed of opaque plastic and provided with a cover opening facing at least one of said plural lighting windows, said second adapter cover is formed of opaque plastic and covers said plural lighting windows.

14. A method for producing a photographic print comprising:
reading out an image recorded on a photographic film:
reading out an optical code expressed by at least one bit mark which is recorded at a time of photographing to correspond to said image;
performing photofinishing to said image based on said optical code; and
printing a processed image on a recording medium.

15. A method for producing a photographic print defined in claim 14, wherein said photofinishing includes sepia photofinishing for producing a sepia photographic print, monochrome photofinishing for producing a monochrome photographic print, color photofinishing for producing a color photographic print, and frame-adding photofinishing for producing a frame-added photographic print.

16. A method for producing a photographic print defined in claim 15, further comprising a step for reading out a film data prerecorded on said photographic film, said photofinishing is performed based on said film data and said optical code.

17. An adapter cover removably attached to a camera, said camera including at least one lighting window formed on a front face of said camera body and one or more photography data optical paths for recording bit marks on the outside of an exposure area by guiding the external light from said lighting window to said photographic film, at least one of said bit marks expressing an optical code, said adapter cover comprising:
a front adapter cover removably attached to said front face of said camera body, said front adapter cover blocking at least one of said photography data optical paths.
